(19) United States
(12) Patent Application Publication
(10) Pub. No.: US 2006/0044733 A1
(43) Pub. Date: Mar. 2, 2006

(54) Buried capacitors for multi-layer printed circuit boards

(75) Inventor: Lionel Fullwood, Kowloon (HK)

Correspondence Address: REED SMITH, LLP, TWO EMBARCADERO CENTER, SUITE 2000, SAN FRANCISCO, CA, 94111, US

(73) Assignee: WKK Distribution, Ltd.

(21) Appl. No.: 10/932,221

(22) Filed: Sep. 1, 2004

(51) Int. Cl. H01G 4/228

(52) U.S. Cl. 361/306.1

(57) ABSTRACT

Multiple capacitors of different values are formed in multi-layer printed circuit boards. Mirror image plates are formed on facing internal copper layers of printed circuit boards. The plates are coated with a dielectric material, preferably a liquid “ink,” such as a titanium dioxide liquid. At least one layer of bonding material is placed between the circuit board layers, having cut-outs to receive the plates, and to encapsulate the dielectric material. The cured package can contain multiple capacitors of different values in a single layer.

### BACKGROUND OF THE INVENTION

1. Field of the Invention

The present invention relates generally to the manufacture of buried capacitors in printed circuit boards, and more particularly to capacitors formed within multi-layer printed circuit boards.

2. Description of the Related Art

Traditionally, Printed Circuit Boards (PCBs) use capacitors mounted on an external surface of the board. Mounting can be either by the older through-hole technology, or more recently by the use of Surface Mount techniques. In both instances, this external mounting requires a large amount of the “real estate” available on all board layers, for both the actual mounting as well as for the interconnection requirements.

As discussed in the article “Putting Passives In Their Place,” Richard Ulrich and Leonard Shaper, IEEE Spectrum, July 2003, pgs. 26-30, a current limitation on the reduction in size of electronic devices is the amount and size of discrete devices (capacitors, resistors and inductors) that are mounted on printed circuit board surfaces. These devices are not easily integrated into an integrated circuit module, and therefore must be mounted externally on the printed circuit board. If these devices could be integrated within (i.e. buried within) the printed circuit board itself, however, the overall size of the board could be reduced. In addition, such integration could lead to reduced costs, faster clock speeds, greater design flexibility and improved circuit performance.

Presently, the insertion of resistors in buried circuit board layers is quite common. However, for capacitors, the process is much more difficult. One such approach is outlined in “Buried Capacitance and Thin Laminates,” Nicholas Biunno and Greg Schroeder, CircuiTree, March, 2004. In this article, the authors discuss various buried distributive capacitance products. These products generally provide a plane of capacitance of a single value. This solution may reduce the number of interconnections, but it does not provide for multiple capacitor values. Current problems in manufacturing multiple values in a single layer include:

1. The inability to obtain standard or reproducible results in a given process (process variations).

2. The inability of the finished product to allow for multiple thermal cycles without degradation. In some instances, the PCB loses capacitance with each thermal cycle.

3. Poor adhesion of the capacitative materials to the materials of the PCB multi-layer.

4. The inability of the manufacturing processes to obtain linear values, in order to produce different capacitive values on the same circuit layer. Note: The addition of more distributive-type capacitive layers to provide for differing values, obviates any benefits obtained by burying the capcitor layers.

5. Process parameters that are difficult to implement in actual manufacturing.

Thus, there is a need for an improved apparatus and method of manufacture for burying several different capacitor values in a single layer of a printed circuit board, in order to provide even greater design flexibility and cost reduction.

### SUMMARY OF THE INVENTION

In general, the present invention is a method of manufacturing buried capacitors in multi-layer printed circuit boards, and the capacitors and printed circuit boards formed by the method.

According to a method of the present invention, a capacitor can be manufactured in a multi-layer printed circuit board by forming an associated metal plate on two adjacent layers of a multi-layer printed circuit board, forming an electrical connection to each metal plate and to each layer adjacent to the layer containing the metal plate to provide for systems integration, etching a circuit pattern into the layers adjacent to each metal plate as necessary, coating each metal plate with a dielectric material, creating at least one piece of bonding material (called pre-preg within the industry) having an opening corresponding to the location of the associated metal plates, placing at least one piece of this bonding material between the adjacent layers of the multi-layer printed circuit board, such that the opening aligns with the associated metal plates coated with the dielectric material, and then curing the multi-layer printed circuit board to form a single laminated structure. The dielectric material is preferably an organic adhesive material filled with any of a number of metal oxides such as titanium dioxide, that can be applied using an ink-jet, a silk-screen process, or any other coating technique, in order to apply a precisely located film of uniform thickness.

In one embodiment, a capacitor is formed between layers of a printed circuit board, the capacitor comprising a first metal plate formed on a first printed circuit board, a second metal plate formed on a second printed circuit board, and a dielectric material between the first and second metal plates, wherein when the first and second circuit boards are laminated together, a bonding material surrounds a periphery of the first and second metal plates, such that the dielectric material is encapsulated between the metal plates and by the bonding layer.

Additionally, a multi-layer printed circuit board structure can be formed having at least one buried layer of capacitors, the circuit board structure comprising a first core material, a first metal layer on a top surface of the first core material to provide electrical connections and at least one first metal plate on a bottom surface of the first core material forming one plate of a capacitor. The printed circuit board's structure also has a second core material, a second metal layer on a bottom surface of the second core material to provide electrical connections and at least one second metal plate on a top surface of the second core material forming a second plate of the capacitor, the at least one first and second metal plates aligned with each other. A dielectric material is placed between the at least one first and second metal plates, and a bonding material formed around a periphery of the metal plates to fill in any gaps between the first and second core materials and to encapsulate the dielectric material between the metal plates.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates two internal cores of copper foil over a laminate;

FIG. 2 illustrates the two cores with a hole drilled to provide connectivity to other layers;

FIG. 3 illustrates the copper cores having the holes metallized to provide electrical connectivity;

FIG. 4 illustrates the copper cores etched, and having mirror image plates formed on the internal surfaces;

FIG. 5 illustrates the mirror image plates coated with a dielectric material;

FIG. 6 illustrates the addition of a bonding layer of material such as pre-preg to encapsulate the internal plates;

FIG. 7 illustrates the cured package, complete with internal capacitors;

FIG. 8 illustrates a piece of bonding material, such as pre-preg, with cut-outs for encapsulating the internal capacitors;

FIG. 9 illustrates one internal layer of the capacitor plates; and

FIG. 10 is a graph showing the average capacitance (of five different boards) of the capacitors formed as shown in FIG. 9.

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

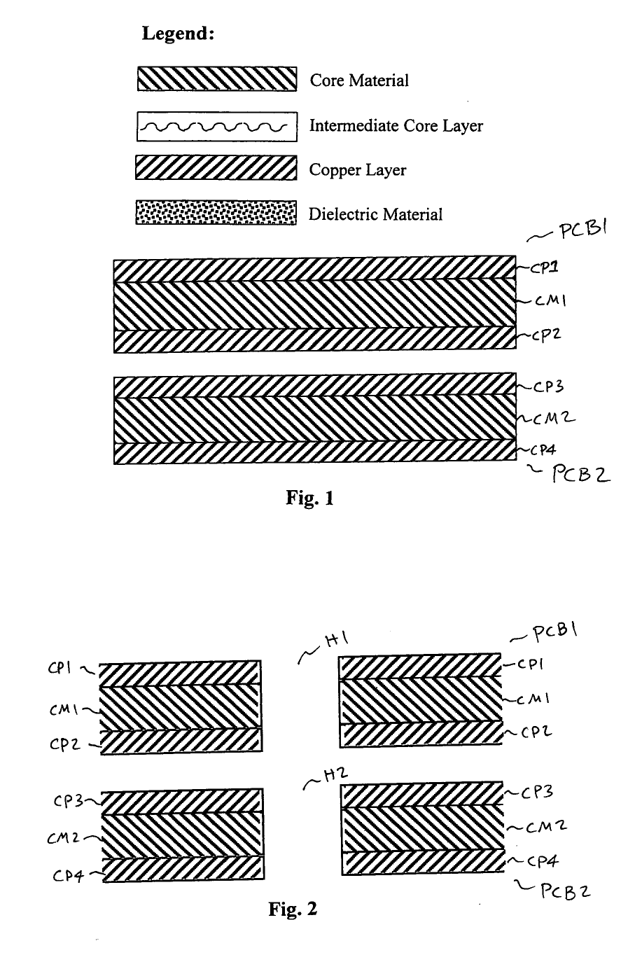

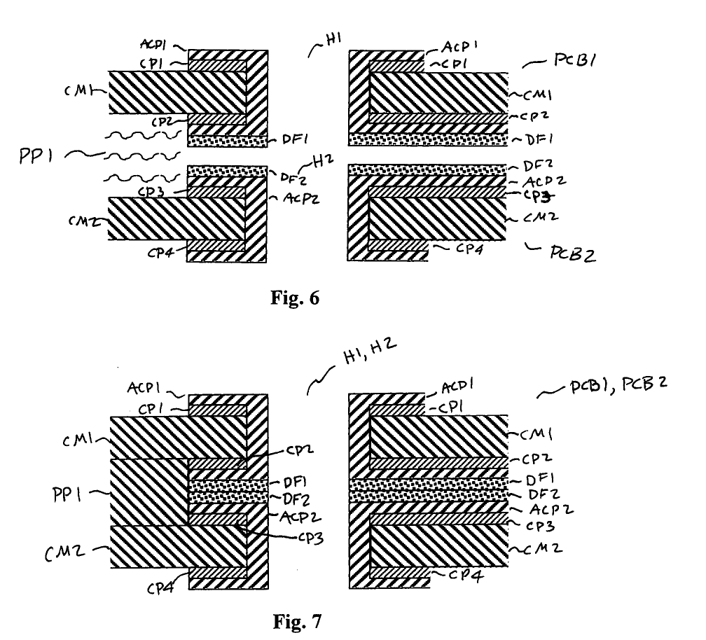

In general, the present invention is an improved structure for buried capacitors in multi-layer printed circuit boards, and a method of manufacturing such capacitor structures and printed circuit boards containing them. The details of the construction of the buried capacitors of the present invention will be described with reference to FIGS. 1-7. These figures show sequentially the construction of one capacitor in a buried layer. It will be appreciated that multiple capacitors, of varying values, can be constructed in this layer as well.

In FIG. 1, two double-sided printed circuit boards (PCBs) PCB1, PCB2 are shown. These may be constructed as standard PCBs as is known in the industry. For example, the metallic layers may be formed of a copper foil CP1, CP2, CP3, CP4 adhered to both sides of a standard core material CM1, CM2, such as FR4, BT or polyimide. The two boards PCB1, PCB2 are processed in such a way that the inner faces CP2, CP3 are “mirror images” of each other.

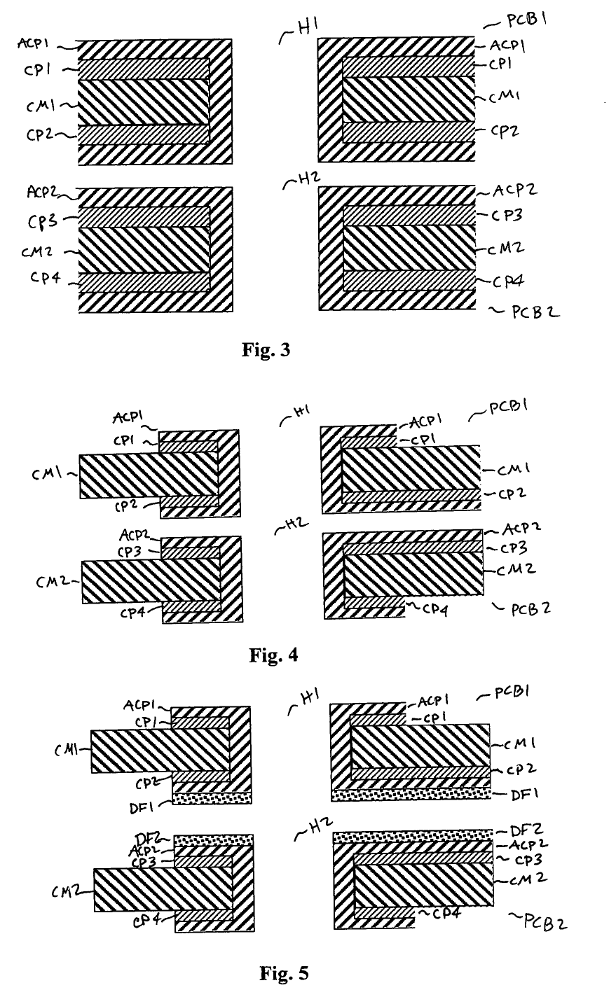

As shown in FIG. 2, a hole H1, H2 (i.e. a “via”) is drilled in each board PCB1, PCB2 in order to form an electrical connection from each external layer CP1, CP4 to the interior capacitor that is to be formed. Next, as illustrated in FIG. 3, additional copper plating ACP1, ACP2 is added to the two boards PCB1, PCB2 in order to form a conductive path through the holes H1, H2. The boards PCB1, PCB2 are then etched, as shown in FIG. 4, to form the standard circuit traces on the external surfaces CP1, CP4 of the boards, and also to form copper plates CP2, CP3 which form the basis of the embedded capacitor. The copper surfaces are then treated to improve their adhesion properties, using an oxide treatment, oxide reduction, or one of the other known adhesion improvement processes such as silver or tin plating.

The next step in the process is to coat the interior copper plates CP2, CP3 with a dielectric film DF1, DF2. In a preferred embodiment, this film is a titanium dioxide “ink,” which is applied using an ink jet system to a coat a precisely defined thickness of ink onto the surface of the copper plates. Other materials may be used as well, including palladium salts or oxides, or tantalum oxides. Alternatively, a silk screening process could be used to provide the same precisely defined thickness of ink. The ink is then allowed to partially dry to remove most of the solvent prior to the PCB lamination process.

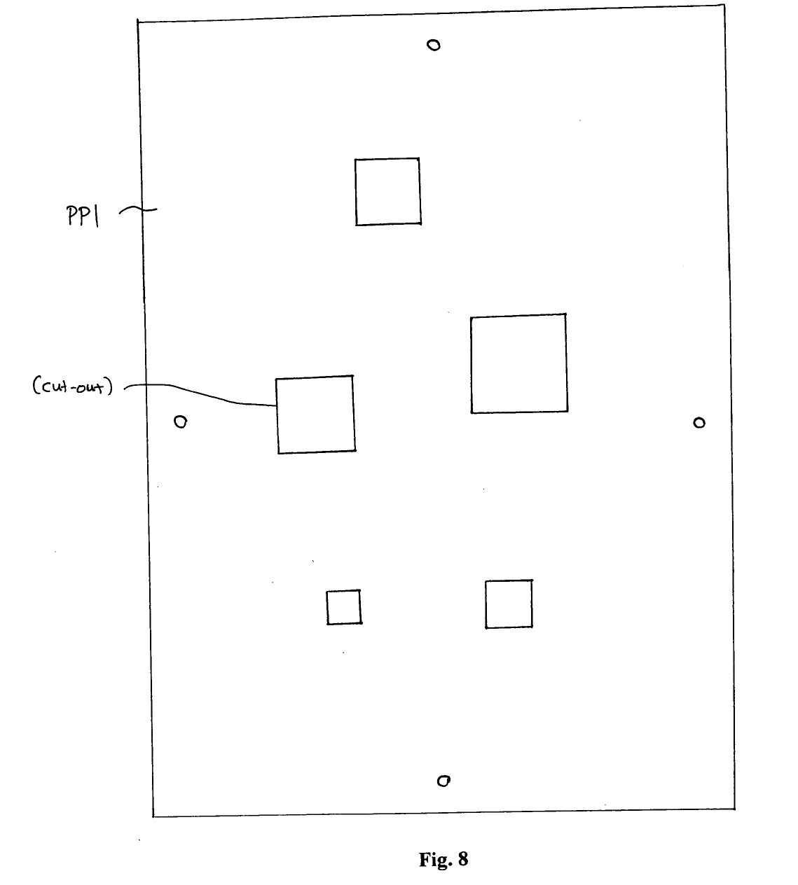

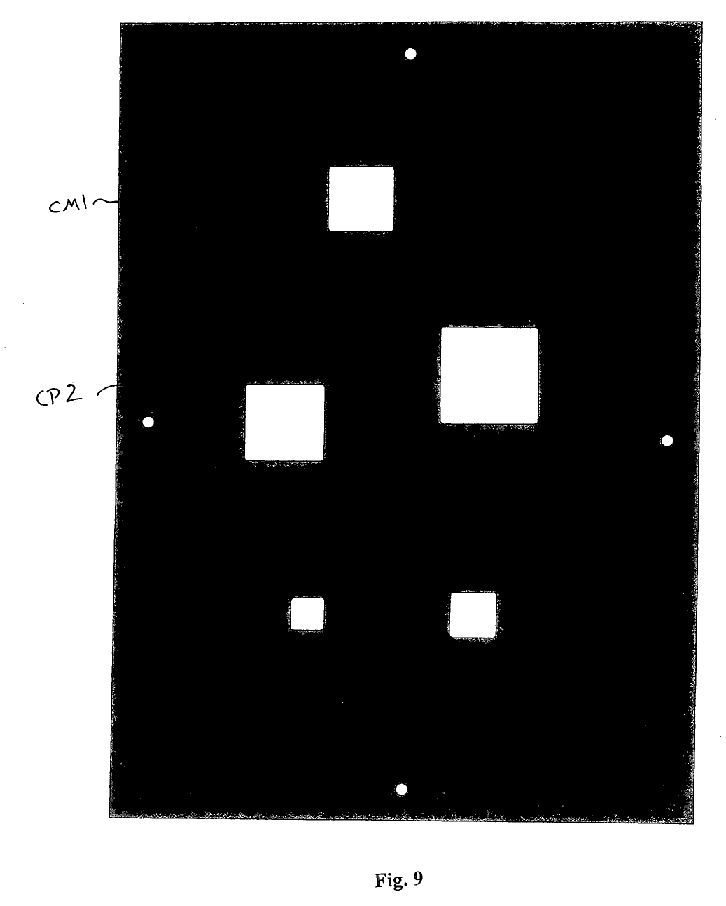

At least one pre-formed sheet of “pre-preg” bonding material PP1 is placed between the two PCBs, PCB1, PCB2. In further detail, as shown in FIG. 8, the pre-preg material PP1 is formed with cut-outs for the various copper plate sets on the interior surfaces CP2, CP3 of the PCBs. For example, if eight capacitors are to be formed, then the pre-preg material has eight cut-outs aligned with the respective copper plates. Additional sheets of pre-preg material may be used, depending on the required thickness needed to fill the “gap” between the cores of the PCBs. Not only does the pre-preg fill this gap, but it also advantageously acts as a “dam” for the liquid dielectric material. During further processing, the cut-out pre-preg keeps the dried liquid dielectric material localized with each copper plate, preventing leakage which could otherwise adversely affect the value of the capacitors. This construction therefore improves the yield of the boards as well.

As illustrated in FIG. 7, the entire package is then cured in a multi-layer press to form a single laminated block. Under normal circumstances, the resin from the pre-preg fills the interconnection holes, ensuring system integrity. The core package with internal capacitors in now compete. Additional circuit board layers may be added to the core, as is known in the art.

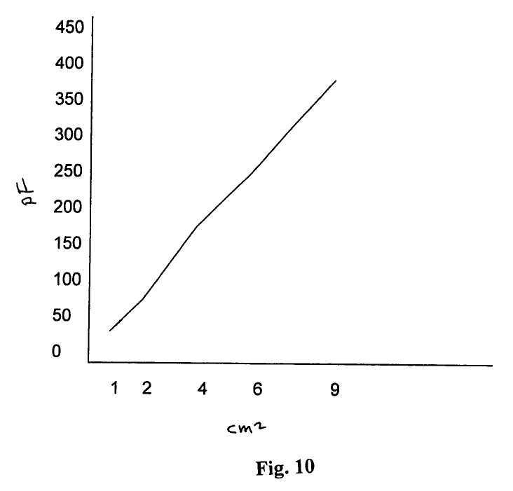

In a preferred embodiment, the capacitors are formed as generally rectangular plates, as shown in FIG. 9. However, any shapes could be used without departing from the present invention, such as circles or triangles. The graph in FIG. 10 illustrates the average capacitance (of five different boards) in picofarads for capacitors shown in FIG. 9, formed according to the present process.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A capacitor formed between layers of a printed circuit board, the capacitor comprising:
a first metal plate formed on a first printed circuit board;
a second metal plate formed on a second printed circuit board; and
a dielectric material between the first and second metal plates;
wherein when the first and second circuit boards are laminated together, a bonding material surrounds a periphery of the first and second metal plates, such that the dielectric material is encapsulated by the metal plates and the bonding material.

2. The capacitor of claim 1, wherein a hole is drilled into the first and second metal plates and plated with a metal in order to form an electrical connection.

3. The capacitor of claim 2, wherein the first and second metal plates are formed as mirror images of each other.

4. The capacitor of claim 1, wherein the dielectric material is titanium dioxide.

5. The capacitor of claim 1, wherein the dielectric material is a tantalum oxide.

6. The capacitor of claim 1, wherein the dielectric material is a palladium salt or oxide.

7. The capacitor of claim 1, wherein the dielectric material comprises a liquid which can be applied using either an ink-jet or silk-screen process.

8. The capacitor of claim 1, wherein the first and second plates are formed of copper.

9. A multi-layer printed circuit board structure having at least one buried capacitor, the circuit board structure comprising:
a first core material;
a first metal layer on a top surface of the first core material to provide electrical connections;
at least one first metal plate on a bottom surface of the first core material forming one plate of a capacitor;
a second core material;
a second metal layer on a bottom surface of the second core material to provide electrical connections;
at least one second metal plate on a top surface of the second core material forming a second plate of the capacitor, the at least one first and second metal plates aligned with each other;
a dielectric material between the at least one first and second metal plates; and
a bonding material formed around a periphery of the metal plates to fill in any gaps between the first and second core materials and to encapsulate the dielectric material between the metal plates.

10. The circuit board structure of claim 9, wherein the bonding material comprises multiple sheets of material.

11. The circuit board structure of claim 9, wherein dielectric material is titanium dioxide.

12. The circuit board structure of claim 9, wherein the dielectric material is a tantalum oxide.

13. The circuit board structure of claim 9, wherein the dielectric material is a palladium salt or oxide.

14. The circuit board structure of claim 9, wherein the dielectric material comprises a liquid which can be applied using either an ink-jet or silk-screen process.

15. The circuit board structure of claim 9, wherein the metal plates are formed as mirror images.

16. The circuit board structure of claim 9, wherein the first and second metal layers are etched to provide electrical circuit connections.

17. The circuit board structure of claim 9, wherein the bottom surface of the first core material and the top surface of the second core comprise a plurality of separate metal plates, each surface having a plate corresponding to a plate on the other surface, such that a plurality of capacitors of different values are formed within the same layer.

18. A method of manufacturing a capacitor in a multi-layer printed circuit board, the method comprising:
forming associated metal plates on two adjacent layers of a multi-layer printed circuit board;
forming an electrical connection to each metal plate and to a layer adjacent to each metal plate;
etching a circuit pattern into the layers adjacent to each metal plate as necessary;
coating each metal plate with a dielectric material;
creating at least one piece of filler core material having an opening corresponding to the location of the associated metal plates;
placing the at least one piece of filler bonding material between the adjacent layers of the multi-layer printed circuit board, such that the opening aligns with the associated metal plates coated with the dielectric material; and
curing the multi-layer printed circuit board to form a single laminated structure.

19. The method of claim 18, further comprising:
processing the metal plates to improve the adhesion properties of the plates prior to coating the plates with the dielectric material.

20. The method of claim 19, wherein the dielectric material is selected from the group consisting of titanium dioxide, tantalum oxide, palladium salts, and palladium oxides.

21. The method of claim 20, wherein the dielectric material is formulated as a liquid and applied using an ink-jet or silk-screen system.

22. The method of claim 21, wherein the dielectric material is allowed to partially dry prior to the curing process.

23. The method of claim 22, wherein a plurality of associated metal plates are formed of different sizes on the adjacent layers to form capacitors of different values within the same layer.

24. The method of claim 23, wherein the associated metal plates are formed as mirror images of each other.

25. A multi-layer printed circuit board formed by the method of claim 18.
